(19) United States
(12) Patent Application Publication
(10) Pub. No.: US 2026/0331919 A1
(43) Pub. Date: Oct. 22, 2026

(54) POWER COMPENSATOR IN BATTERY ENERGY STORAGE SYSTEMS

(71) Applicant: Fluence Energy, LLC, Arlington, VA (US)

(72) Inventors: Benjamin Joseph Braun, Berlin (DE); Stefan Henninger, Obermichelbach (DE); Veeraiah Boddu, KORRAPADU (IN)

(73) Assignee: Fluence Energy, LLC, Arlington, VA (US)

(21) Appl. No.: 19/652,529

(22) Filed: Apr. 20, 2026

Related U.S. Application Data
(60) Provisional application No. 63/792,462, filed on Apr. 22, 2025.

(51) Int. Cl. H02J 3/32; H02J 3/17; H02J 3/1835; H02J 7/00; H02J 103/35

(52) U.S. Cl. CPC H02J 3/32; H02J 3/17; H02J 3/1835; H02J 7/855; H02J 2103/35

(57) ABSTRACT

A system and a method for compensating losses in a battery energy storage system (BESS). A power compensator includes a parameter circuit and a controller. The parameter circuit is configured to provide N power parameters associated with equipment connected between a group of rechargeable batteries and a point of connection (POC). The controller is configured to send a command to a dispatcher based on the N power parameters. The command configures a group circuit including the group of rechargeable batteries to generate an output corresponding to an expected demand. The N power parameters are used to compensate for a balance of plant (BOP) deviations.

### CROSS-REFERENCE TO RELATED APPLICATIONS

The present application claims the benefit of priority to U.S. Provisional Application No. 63/792,462 filed on Apr. 22, 2025, which is hereby incorporated by reference in its entirety.

### TECHNICAL FIELD

The disclosure generally relates to battery energy storage systems (BESS). More particularly, the subject matter disclosed herein relates to power control for BESS.

### BACKGROUND

Battery energy storage systems (BESS) are rechargeable batteries that store energy from a variety of energy sources (e.g., solar, wind) and release power into electrical grid to deliver electricity for distribution to consumers or other grid services. BESS have been integrated with renewable energy sources and increasingly played an important role for both residential and non-residential users.

Balance of plant (BOP) in the context of power engineering refers to all the auxiliary and supporting components or subsystems in a power plant that are needed to maintain stable and efficient operations of delivering power according to demands. Some important BOP components include power transformers, circuit breakers, switchgear, and electrical cables and/or busbars.

There are a few factors in the power delivery and distribution that may lead to BOP deviations. One factor is that the power commands are sent to the power conversion system (PCS) at low voltage while most of the equipment is located between the grid and the PCS. Other factors may include the measurements of auxiliary equipment and load fluctuations. These BOP deviations result in an error between the desired BESS output, point of interconnection (POI), point of common coupling (PCC), or point of connection (POC), and the actual delivered power. This error causes degraded performance, customer unsatisfaction, penalties, and/or revenue loss.

Techniques to correct this type of error are inadequate. One popular technique is to use outer plant control loops to adjust the BESS output by introducing a small correcting signal based on a reference value. This technique requires a precise measurement of the output and applies the correcting signal to adjust the output accordingly. The process of measuring the output, applying the correction, and checking the result often requires tuning, which is often time-consuming, labor intensive, and therefore costly because tuning is a fine balance between stability and response speed. Additionally, the provision of active power induces higher reactive demand from the BOP while the provision of reactive power induces higher active losses from the BOP—outer plant control loops do not anticipate such coupling. Increasingly, many services require the provision of active and/or reactive power to be quickly provided to stabilize grid frequency and/or voltage. Such a demand for a fast response time cannot be met by traditional techniques using outer plant control loops.

### SUMMARY

To overcome these issues, systems and methods are described herein for a technique of applying feed-forward control using a deviation model. A system and a method for compensating alternating current (AC) plant deviations in a battery energy storage system (BESS). A power compensator includes a parameter circuit and a controller. The parameter circuit is configured to provide N power parameters associated with equipment connected between a group of rechargeable batteries and a point of connection (POC). The controller is configured to send a command to a dispatcher based on the N power parameters. The command configures a group circuit including the group of rechargeable batteries to generate an output corresponding to an expected demand. The N power parameters are used to compensate for a balance of plant (BOP) deviations including cross-coupling between the provisions of active power and reactive power.

### BRIEF DESCRIPTION OF THE DRAWINGS

In the following section, the aspects of the subject matter disclosed herein will be described with reference to exemplary embodiments illustrated in the figures, in which:

FIG. 1 is a block diagram illustrating a system according to an embodiment.

FIG. 2 is a diagram illustrating a power compensator according to an embodiment.

FIG. 3 is a diagram illustrating a parameter circuit according to an embodiment.

FIG. 4 is a diagram illustrating a BOP deviation model using function and/or table according to an embodiment.

FIG. 5 is a diagram illustrating a BOP deviation model using a machine learning model according to an embodiment.

FIG. 6 is a flowchart illustrating a process of compensating power according to an embodiment.

FIG. 7 is a flowchart illustrating a process of providing power parameters according to an embodiment.

FIG. 8 is a diagram illustrating a processing system according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

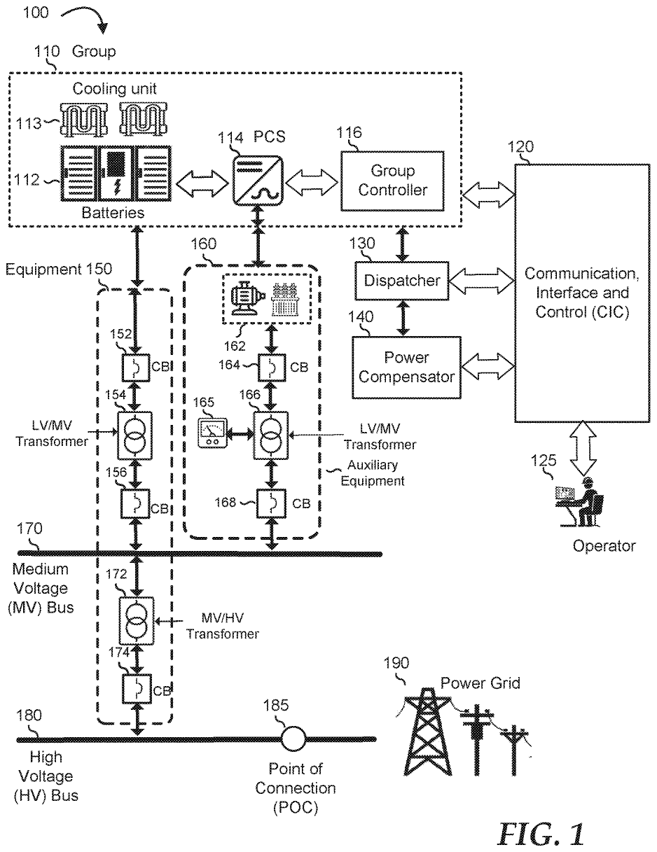

FIG. 1 is a block diagram illustrating a system 100 according to an embodiment. The system 100 may be referred to as a battery plant or a power plant. includes a group circuit 110, a communication, interface, and control (CIC) 120, a dispatcher 130, a power compensator 140, an equipment 150, an auxiliary equipment 160, and a point of connection (POC) 185. The equipment 150 includes a first circuit breaker (CB) 152, an LV/MV transformer 154, a second CB 156, an MV/HV transformer 172, and a third CB 174. The auxiliary equipment 160 includes equipment 162, a first auxiliary CB 164, an auxiliary transformer LV/MV 166, a meter 165, and a second auxiliary CB 168. The system 100 may include more than these components. The arrangement of the various devices and equipment is for illustrative purposes only. In addition, there may be multiple groups similar to the group circuit 110. The individual groups are not always perfectly symmetrical (in their construction, but also in the amount of BOP they pass through to get to the POC); so asymmetric commands are needed to balance. The dispatcher 130 is responsible for proper distribution of the total power command to each individual group.

The group 110 represents components in a group of a multi-level hierarchical structure. It includes a Battery Energy Storage Systems (BESS). The batteries in the BESS are often divided into groups for ease of management. For example, suppose the number of all batteries or battery modules in the BESS is N. These N batteries form an array of N batteries. The array may be divided in m groups, each having N/m batteries. Each of these may be referred to as a core. Each core may be further divided into smaller groups to form nodes. Each node may be formed by cubes and so on. For clarity and brevity, the term “group” refers to any of these levels. The group 110 includes a set of batteries 112, a cooling unit 113, a power conversion system (PCS) 114, and a group controller 116. The batteries 112 are rechargeable batteries. The types of batteries may include lithium-ion and lead-acid, but lithium-ion is the most popular type. The cooling unit 113 provides cooling to the batteries 112. Other equipment (e.g., PCS) may also have their own cooling unit. The cooling may be carried out by any cooling method, including air and liquid. In one embodiment, the cooling unit 113 employs liquid cooling. It typically includes tubes that carry liquid coolant through the racks that house the batteries 112. The PCS 114 converts the direct current (DC) to alternating current (AC) for use at the POC 185. When the batteries 112 need DC power, the PCS 114 may convers AC from an AC source to DC to the batteries. The group controller 116 performs control functions to elements in the group 110. In particular, it controls the liquid cooling unit 113 to trigger a cooling action.

The CIC 120 provides communication, interface, and control to various parts and components in the system 100. The communication uses communication protocols to allow exchange information among various components in the system 100. Examples of the protocols are Modbus TCP (Transmission Control Protocol), DNP3 (Distributed Network Protocol 3), and IEC (International Electrotechnical Commission) 104. The control may include data acquisition, sensing operations, and monitoring. Examples include SCADA (Supervisory Control and Data Acquisition systems which use networks, computers, and human-machine interfaces (HMIs) to gather and analyze data in real time. The CIC 120 also provides interfaces to various components and devices in the system 110, including a user interface to an operator 125. In one embodiment, the CIC 120 receives measurements from various devices that monitor and measure operational parameters (e.g., voltage, current, power) of equipment including auxiliary equipment, voltage transformers.

The dispatcher 130 dispatches command instructions or data to the group 110. The command instructions or data may correspond to control and monitor actions such as activating, energizing, or actuating various devices or equipment in the system. The power compensator 140 compensates the reduced power at the POC 185 due to deviations in the equipment 150 and the auxiliary equipment 160 in the system. The first CB 152 acts to connect the PCS 114 to other equipment and to isolate the PCS 114 from the other equipment. The LV/MV transformer 154 steps up a low voltage (LV) at the LV side at the first CB 152 to a medium voltage (MV) at the MV side at the second CB 156. It may also step down the MV at the second CB 156 to a LV at the first CB 152. The second CB 156 connects the LV/MV transformer 154 to an MV bus 160. The MV/HV transformer 172 steps up the MV at the MV side at the MV bus 160 to a high voltage (HV) at the HV side at the third CB 174. When it is used in a bidirectional mode, the MV/HV transformer 172 may also step down the HV at the third CB 174 to the MV at the MV bus 170. In the auxiliary equipment 160, the CB 164, the LV/MV transformer 166, and the CB 168 perform similar actions. The equipment 162 include various devices or equipment that support the power generation and distribution of the system. These devices or equipment may include pumps, switchgears, boilers, The POC 185 is the point of connection to a power grid 190. It may also be the connection point from another energy source.

The first CB 152, the LV/MV transformer 154, the second CB 156, the MV/HV transformer 172 and the CB 164 form the equipment 150. The equipment 150 and the auxiliary equipment 160 cause deviations along the way from the PCS 114 to the POC 185. Because of these deviations, the output power of the PCS 114 is impacted and the power at the POC 185 is inaccurate.

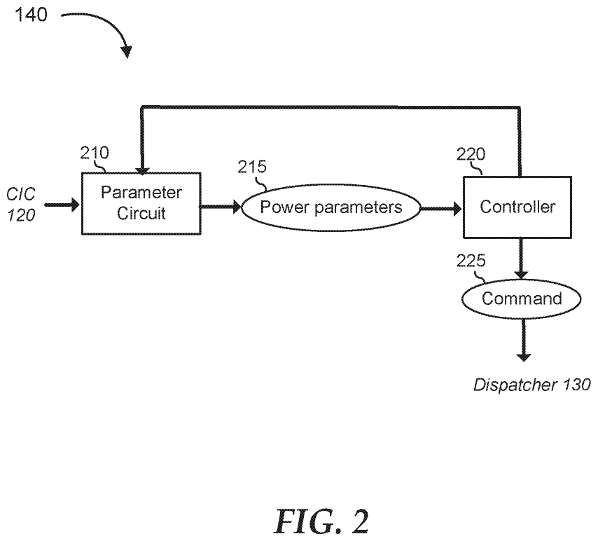

FIG. 2 is a diagram illustrating the power compensator 140 shown in FIG. 1 according to an embodiment. The power compensator 140 includes a parameter circuit 210 and a thermal controller 220. The power compensator 140 may include more or less than the above components.

The parameter circuit 210 is configured to provide N power parameters 215. While the power parameters 215 are generated inside the parameter circuit 210, it is shown to be external to the parameter circuit 210 to illustrate that the parameters are sent to the controller 220. N is a positive integer, associated with the equipment 150 connected between a multitude of PCSes like the PCS 114 and the POC 185. In one embodiment, the N power parameters 215 may be determined based on specification details of the corresponding equipment. As will be described in the following, the N power parameters 215 are parameters that compensate for a balance of plant (BOP) deviations. The N power parameters 215 are determined based on a BOP model. In some embodiments, the N power parameters 215 (P_{array, dispatch}, Q_{array, dispatch}) may be determined from the settings (Pₛₑₜ, Qₛₑₜ) and the model parameters (P₁, Q₁) as follows:

(P_{array, dispatch}, Q_{array, dispatch})=(P₁, Q₁)+(P₂, Q₂) (1)

where (P₁, Q₁) are obtained from the BOP model and

(P₂, Q₂)=(Pₛₑₜ, Qₛₑₜ)−(P_{aux, meas}, Q_{aux, meas}) (2)

where (P_{aux, meas}, Q_{aux, meas}) are measurements from the auxiliary equipment and (Pₛₑₜ, Qₛₑₜ) are the settings.

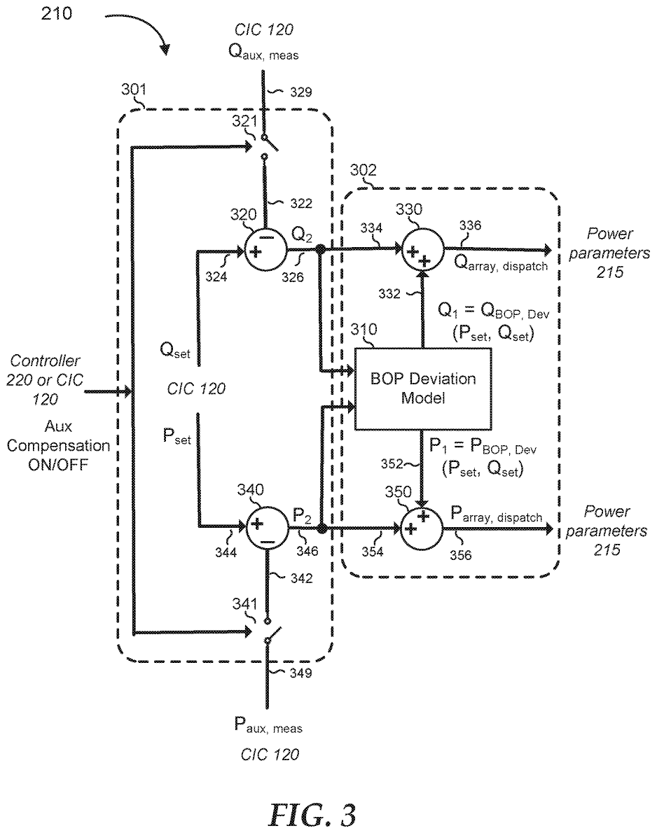

Equations (1) and (2) are depicted in FIG. 3.

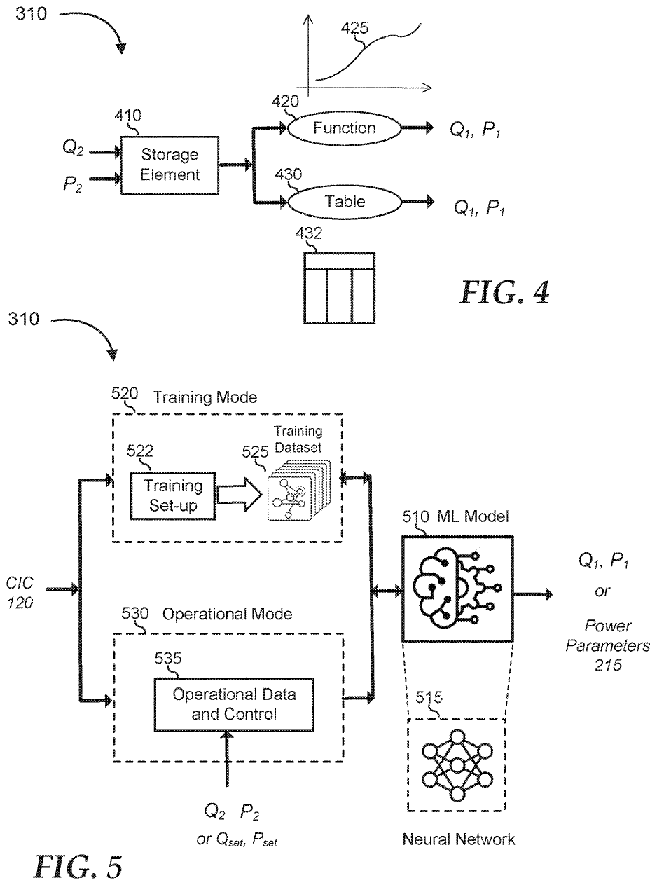

As will be described later in FIG. 3, in one embodiment, the N power parameters 215 are obtained from a BOP deviation model. The BOP deviation model may include a function and/or a table as shown in FIG. 4, and a machine learning (ML) model as shown in FIG. 5.

The thermal controller 220 is configured to send a command 225 to the dispatcher 130 based on the parameter circuit 210. The command 225 configures the group circuit 110 including the PCS 114 to generate an output corresponding to an expected demand. The N power parameters 215 are used to compensate for a balance of plant (BOP) deviations. The thermal controller 220 may be integrated into the group controller 116. In some embodiments, the thermal controller 220 is configured to collect, organize, format, and transmit the control data while the group controller 116 performs the actual control functions (e.g., sending commands to actuators) based on the control data.

FIG. 3 is a diagram illustrating the parameter circuit 210 shown in FIG. 2 according to an embodiment. The parameter circuit 210 includes an adjustment circuit 301 and a model circuit 302. The adjustment circuit 301 determines (P₂, Q₂) in Equation (2). The model circuit 302 determines the (P_{array, dispatch}, Q_{array, dispatch}) in Equation (1) where the (P_{array, dispatch}, Q_{array, dispatch}) constitutes the N parameters 215. The adjustment circuit includes a subtractor 320, a switch 321, a subtractor 340, and a switch 341. The model circuit 302 includes a BOP deviation model 310, an adder 330, and an adder 350. The parameter circuit 210 may include more or less than the above components. The parameter circuit 210 depicts a measurement process to express the power (active and reactive) dispatched to the PCS 114. It provides an example on how to apply the parameter circuit within a controller.

An ON/OFF signal for auxiliary compensation from the controller 220 or the CIC 120 turns on or turns off switches 321 and 341. The CIC 120 provides the settings Qₛₑₜ and Pₛₑₜ for the reactive and active powers. The CIC 120 also provides measurements of the auxiliary equipment Q_{aux, meas} and P_{aux, meas}. The branch for the reactive power Q operates as follows. The subtractor 320 performs the subtraction Q₂=Qₛₑₜ−Q_{aux, meas}. The switch 321 is used to control the compensation ON/OFF. The adder 330 generates the Q_{array, dispatch} by adding Q₂ to the term Q₁=Q_{BOP, Dev} (Pₛₑₜ, Qₛₑₜ) from the BOP deviation model 310. The term Q₁ is the value of the Q_{BOP, Dev} at the settings (Pₛₑₜ, Qₛₑₜ). Q₁ is provided based on the particular model used in the BOP deviation model 310.

The branch for the active power P operates in a similar manner. The subtractor 340 performs the subtraction P₂=Pₛₑₜ−P_{aux, meas}. The switch 341 is used to control the compensation ON/OFF. The adder 350 generates the P_{array, dispatch} by adding P₂ to the term P₁=P_{BOP,Dev} (Pₛₑₜ, Qₛₑₜ) from the BOP deviation model 310. The term P₁ is the value of the P_{BOP, Dev} at the settings (Pₛₑₜ, Qₛₑₜ). P₁ is provided based on the particular model used in the BOP deviation model 310.

The BOP deviation model 310 represents a model or structure that generates an adjustment or compensation quantity to the reactive and active powers. If there are no deviations, the settings Qₛₑₜ and Pₛₑₜ will be applied directly to the corresponding power generating equipment. The adjustment or compensation is made to the settings Qₛₑₜ and Pₛₑₜ such that the actual Qₛₑₜ and Pₛₑₜ will be very close to the desired settings. There are two stages or phases of compensation: a first stage performed by the adjustment circuit 301 and a second stage performed by the model circuit 302. In the first stage, the settings are compensated by the real-time actual measurements at the auxiliary equipment. For example, suppose the desired power setting Pₛₑₜ is 100 MW. For simplicity, the following uses only active power. The reactive power is modeled the same way. The losses or deviations as measured at the auxiliary equipment is P_{aux, meas}=−7 MW. Therefore, to compensate for this loss, the adjustment circuit 301 generates P₂=Pₛₑₜ−P_{aux, meas}=100−(−7)=107 MW at the subtractor 340. The adjustment circuit 301, therefore, adjusts a power setting by a power measurement to generate the adjusted power setting P₂. At this point, there may be other deviations that may be caused to other outer plant parameters. This is done in the second stage. These additional deviations are modeled in the BOP Deviation Model 310. The BOP Deviation Model 310 includes models, predictors, or estimators that estimate the additional deviations as caused by the setting of Pₛₑₜ. This additional deviation produces P₁=P_{BOP, Dev} at Pₛₑₜ=P_{BOP, Dev} (Pₛₑₜ). Suppose this deviation is P₁₌14 MW. To compensate for this, the P₁ would be added to P₂ to produce the power parameter to be sent to the dispatch: P_{array, dispatch}=P₂+P₁. In this example, P_{array, dispatch}=107+14=121 MW. In other words, the model circuit 302 in the second stage generates a compensating quantity (P₁) to be combined with the adjusted power setting (P₂) to generate one of the N power parameters using the BOP deviation model 310. Therefore, the setting to be sent to the dispatch will be 121 MW. When the dispatch sends the command to activate the power, the generated power will be 121 MW so that by the time the generate power reaches the POC 185, the losses and/or deviations along the way through the equipment 150 and the auxiliary equipment 160 will cause it to reduce to 100 MW, which is exactly what the desired setting is.

The first-stage adjustment is provided by the measured power parameters through the CIC 120. The second-stage compensation is provided by the BOP Deviation model 310. In one embodiment, there are three ways to create the model. The first way is to use a function. The second way is to use a look-up table. The third way is to use a machine learning (ML) model. These models (function, table, and ML) may be used individually or in combination. They may also be used statically (remaining the same during a course of operation) or dynamically (switching during the course of operations). For example, during a period, the BOP deviation model 310 may use a table. After some time, it may switch to table and ML, etc.

Various embodiments may be configured to realize the parameter circuit 210. In one embodiment, the parameter circuit 210 includes the adjustment circuit 301 and the model circuit 302 as described above. In another embodiment, the model circuit 302 may not be needed and the parameter circuit 210 may include only the adjustment circuit 301. In this case, the adjusted power setting becomes at least one of the N power parameters 215.

FIG. 4 is a diagram illustrating the BOP deviation model 310 shown in FIG. 3 according to an embodiment. The BOP deviation model 310 includes a storage element 410. The BOP deviation model 310 may include more than one component. The storage element 410 may be any suitable storage or memory. It may be a non-volatile memory (e.g., solid state drive (SSD)) or volatile memory whose contents are loaded from other non-volatile memories or generated on-line.

The storage element 410 is configured to store one of a function 420 related to the equipment and a table 430 containing the N power parameters. The function 420 describes the relationship between the quadratic loss in the equipment and the power, and an inductive/capacitive reactive demand and the power. The N power parameters 215 are determined based on a set of data relating to power levels as functions of output power, or obtained from component datasheets. The function 4120 may be formed by a curve-fitting algorithm that represents a set of data points as a curve. The curve may be any suitable curve. The abscissa axis of the coordinate system represents the Q₂, P₂ parameters shown in FIG. 2 and the ordinate axis represents the corresponding Q₁, P₁.

The table 430 stores the discrete values of (Q₂, P₂) and (Q₁, P₁)_{.} that are obtained through experiments, tests, past information, or datasheets. If the input values (Q₂, P₂) are in the table, the corresponding (Q₁, P₁)_{.} will be looked up. If the input values (Q₂, P₂) are not in the table, the corresponding values (Q₁, P₁)_{.} may be generated by interpolation or extrapolation.

FIG. 5 is a diagram illustrating the BOP deviation model 310 shown in FIG. 3 using a machine learning model according to an embodiment. The BOP deviation model 310 includes an ML model 510.

The ML model 510 is configured to be trained by a dataset including measurements power data of the equipment. It operates in two modes: a training mode 520 and an operational mode 530. The training mode 520 is the mode in which the ML model 510 learns about the system and the relationship between the power parameters 215 and the various parameters of the equipment. The training mode 520 includes a training set-up 522 and training dataset 525. The training set-up 522 includes the setting up of the equipment to operate and to produce values for measurements. The training dataset 525 includes the data obtained from the equipment and the power settings that provide the desired power output. The training may take place over a predetermined period or until some stopping criteria are met. After the training is completed, the ML model 510 has learned about the equipment, the losses, and the deviations, and can generate the power parameters according to the power settings.

After the training, the ML model 510 is ready to operate in the operational mode 530. The operational mode 530 includes operation data and control 535. This includes all data or commands that are normally used in an operation of delivering power. In one embodiment, the ML model 510 includes a neural network 515. During training, the weights of the neural network 515 are adjusted according to the training dataset 525. The inputs to the operation data and control 535 may depend on the model and may include the Q₂, P₂ or the (Qₛₑₜ, Pₛₑₜ) as shown in FIG. 3. The outputs of the ML model 510 depend on the inputs and the model and may include Q₁, P₁ or the power parameters 215.

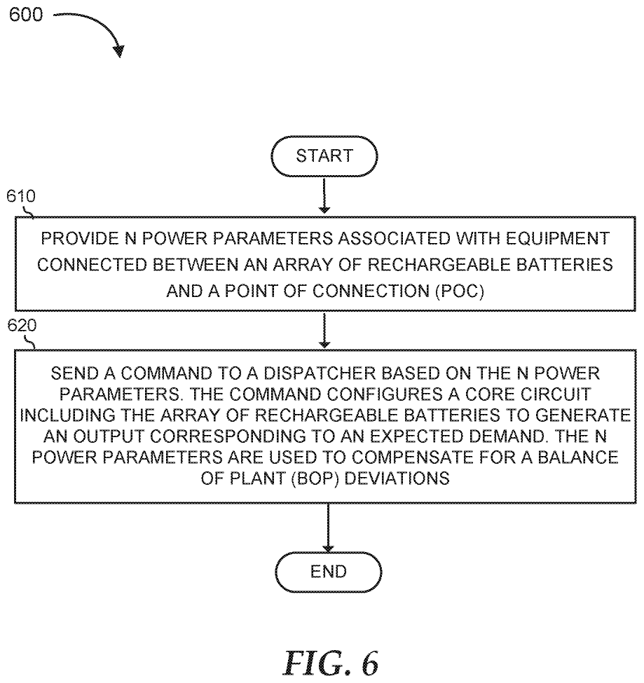

FIG. 6 is a flowchart illustrating a process 600 of compensating power according to an embodiment.

Upon START, the process 600 provides N power parameters associated with equipment connected between a group of rechargeable batteries and a point of connection (POC) (Block 610). The N power parameters may be determined using a two-stage compensation scheme based on measured data and a balance of plant (BOP) deviation model as described in connection with FIG. 3. Next, the process 600 sends a command to a dispatcher based on the N power parameters (Block 620). The command configures a group circuit including the group of rechargeable batteries to generate an output corresponding to an expected demand. The N power parameters are used to compensate for a BOP deviation. The process 600 is then terminated.

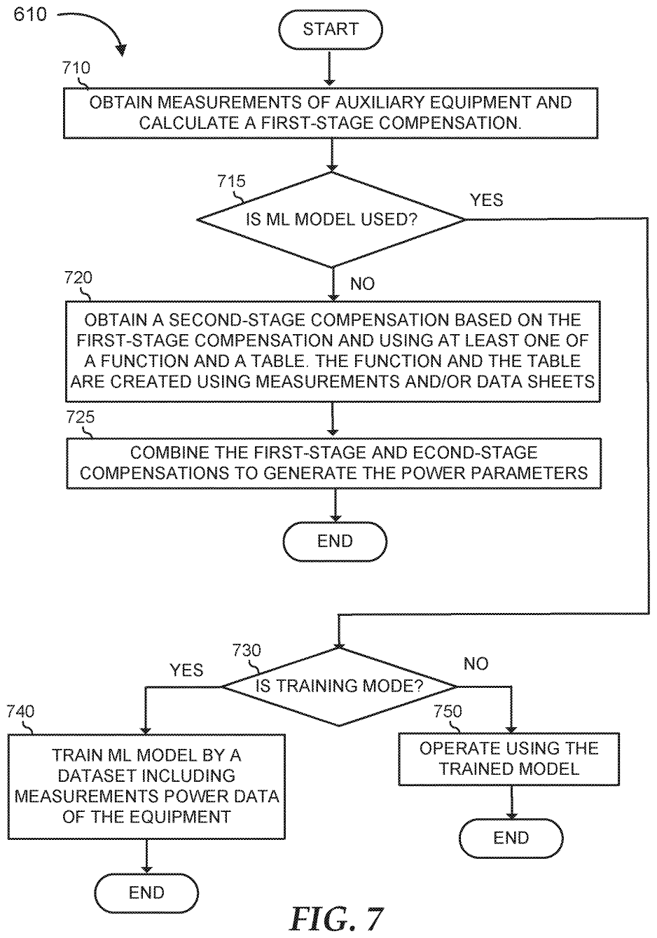

FIG. 7 is a flowchart illustrating the process 610 of providing power parameters shown in FIG. 6 according to an embodiment.

Upon START, the process 610 obtains measurements of the auxiliary equipment and calculates a first-stage compensation (Block 710). This is equivalent to calculation of (Q₂, P₂) in FIG. 3. Next, the process 610 determines if an ML model is used (Block 715). If not (NO at branch 715), the process 610 obtains a second-stage compensation based on the first-stage compensation and using at least one of a function or a table (Block 720). The function and the table are created using measurements and/or information such as data sheets as described in FIG. 3. Then, the process 610 combines the first-stage and second-stage compensations to generate the power parameters (Block 725). The process 610 is then terminated.

If an ML model is used (YES at block 710), the process 610 determines if it is a training mode (Block 730). If so (YES at block 730), the process 610 training the ML model by a dataset including measurements power data of the equipment. The process 610 is then terminated. If an ML model is not used (NO at block 730), the process 610 operates using the trained ML model. The process 610 is then terminated.

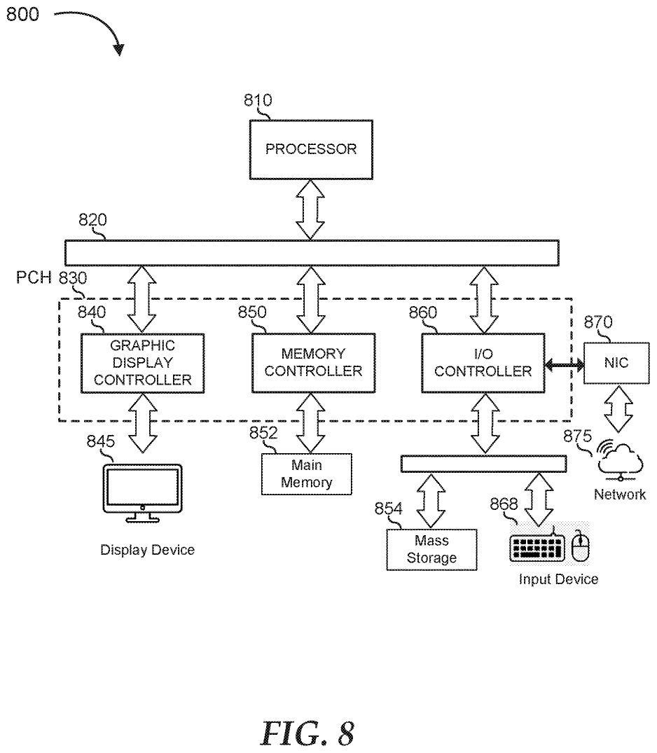

FIG. 8 is a diagram illustrating a processing or computing system 800 according to an embodiment.

The processing system or computing system 800 may be a host in a system on which the power compensator 140 operates. It includes a central processing unit (CPU) or a processor 810, a platform controller hub (PCH) 830, and a bus 820. The PCH 830 may include a graphic display controller (GDC) 840, a memory controller 850, and an input/output (I/O) controller 860. The processing system 800 may include more or less than the above components. In addition, a component may be integrated into another component. As shown in FIG. 8, all the controllers 840, 850, and 860 are integrated in the PCH 830. The integration may be partial and/or overlapped. For example, the GDC 840 may be integrated into the processor 810, the I/O controller 860 and the memory controller 850 may be integrated into one single controller, etc.

The processor 810 is a programmable device that may execute a program or a collection of instructions to carry out a task. It may be a general-purpose processor, a digital signal processor, a microcontroller, or a specially designed processor such as one design from Applications Specific Integrated Circuit (ASIC). It may include a single core or multiple cores. Each core may have multi-way multi-threading. The processor 810 may have simultaneous multithreading feature to further exploit the parallelism due to multiple threads across the multiple cores. In addition, the processor 810 may have internal caches at multiple levels.

The bus 820 may be any suitable bus connecting the processor 810 to other devices, including the PCH 830. For example, the bus 820 may be a Direct Media Interface (DMI).

The PCH 830 in a highly integrated chipset that includes many functionalities to provide interface to several devices such as memory devices, input/output devices, storage devices, network devices, etc.

The I/O controller 860 controls input devices 868 (e.g., stylus, keyboard, and mouse, microphone, image sensor) and output devices (e.g., audio devices, speaker, scanner, printer), and a mass storage 854. The mass storage 854 may also include CD-ROM, hard disk, and solid-state drives (SSDs). It also has a network interface card (NIC) 870 which provides interface to a network and wireless medium 875.

The memory controller 850 controls memory devices such as a main memory 852. The main memory 852 includes random access memory (RAM) and/or the read-only memory (ROM) and other types of memory such as the cache memory or an SSD. The main memory 852 may store instructions or programs, loaded from a mass storage device, that, when executed by the processor 810, cause the processor 810 to perform operations as described above. It may also store data used in the operations. The ROM may include instructions, programs, constants, or data that are maintained whether it is powered or not. The instructions or programs may correspond to the functionalities described above, such as the controller 220 or the ML model 510.

The GDC 840 controls a display device 845 and provides graphical operations. It may be integrated inside the processor 810. It typically has a graphical user interface (GUI) to allow interactions with a user who may send a command or activate a function.

Additional devices or bus interfaces may be available for interconnections and/or expansion. The bus interfaces may be serial or parallel, with or without power delivery, etc.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively, or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. An apparatus comprising:
a parameter circuit configured to provide N power parameters associated with equipment connected between a group of rechargeable batteries and a point of connection (POC); and
a controller configured to send a command to a dispatcher based on the N power parameters;
wherein the command configures a group circuit including the group of rechargeable batteries to generate an output corresponding to an expected demand, and
wherein the N power parameters are used to compensate for a balance of plant (BOP) deviations.

2. The apparatus of claim 1, wherein the parameter circuit comprises:
an adjustment circuit to adjust a power setting by a power measurement to generate an adjusted power setting.

3. The apparatus of claim 2, wherein the parameter circuit further comprises:
a model circuit to generate a compensating quantity to be combined with the adjusted power setting to generate one of the N power parameters,
wherein the compensating quantity is based on a BOP deviation model.

4. The apparatus of claim 3, wherein the BOP deviation model includes at least one of a function, a table, or a machine learning (ML) model.

5. The apparatus of claim 2, wherein the adjusted power setting corresponds to one of the N power parameters.

6. The apparatus of claim 2, wherein at least one of the function or the table is created based on specification details of the equipment.

7. The apparatus of claim 4, wherein the compensating quantity is obtained from the table by one of a look-up operation, an interpolation, or an extrapolation.

8. The apparatus of claim 6, wherein the N power parameters include at least one of an active power and a reactive power.

9. The apparatus of claim 4, wherein the ML model is configured to be trained by a dataset including measurements power data of the equipment.

10. The apparatus of claim 8, wherein the ML model comprises a neural network.

11. A method comprising:
providing N power parameters associated with equipment connected between a group of rechargeable batteries and a point of connection (POC); and
sending a command to a dispatcher based on the N power parameters,
wherein the command configures a group circuit including the group of rechargeable batteries to generate an output corresponding to an expected demand, and
wherein the N power parameters are used to compensate for a balance of plant (BOP) deviations.

12. The method of claim 11, wherein providing N power parameters comprises:
adjusting a power setting by a power measurement to generate an adjusted power setting.

13. The method of claim 12, wherein providing N power parameters further comprises:
generating a compensating quantity to be combined with the adjusted power setting to generate one of the N power parameters,
wherein the compensating quantity is based on a BOP deviation model.

14. The method of claim 13, wherein BOP deviation model includes at least one of a function, a table, or a machine learning (ML) model.

15. The method of claim 12, wherein the adjusted power setting corresponds to one of the N power parameters.

16. The method of claim 12, wherein at least one of the function or the table is created based on specification details of the corresponding equipment.

17. The method of claim 14, wherein the compensating quantity is obtained from the table by one of a look-up operation, an interpolation, or an extrapolation.

18. The method of claim 16, wherein the N power parameters include at least one of an active power and a reactive power.

19. The method of claim 14, wherein the ML model is trained by a dataset including measurements power data of the equipment.

20. A battery energy storage system (BESS) comprising:
a group circuit configured to store energy from an energy source in a group of rechargeable batteries and deliver the stored energy to a point of connection (POC) in a power distribution system; and
a power compensator configured to compensate for deviations in equipment connected between the group of rechargeable batteries and the POC, comprising:
a parameter circuit configured to provide N power parameters associated with the equipment, and
a controller configured to send a command to a dispatcher based on the N power parameters,
wherein the command configures the group circuit to generate an output corresponding to an expected demand, and
wherein the N power parameters are used to compensate for a balance of plant (BOP) deviations.
